(19) United States
(12) Patent Application Publication
(10) Pub. No.: US 2016/0249317 A1
(43) Pub. Date: Aug. 25, 2016

(54) Wireless Array

(71) Applicant: Griffin Technology, Inc., Nashville, TN (US)

(72) Inventors: Thierry Legrain, Murfreesboro, TN (US); David Bowker, Nashville, TN (US); Cameron E. Boone, Nashville, TN (US); Robert Nieman, Brentwood, TN (US)

(73) Assignee: Griffin Technology, Inc., Nashville, TN (US)

(21) Appl. No.: 15/004,728

(22) Filed: Jan. 22, 2016

Related U.S. Application Data
(60) Provisional application No. 62/106,228, filed on Jan. 22, 2015.

(51) Int. Cl. H04W 64/00; H02J 7/34

(52) U.S. Cl. CPC H04W 64/00; H02J 7/34; H04W 84/18

(57) ABSTRACT

A mesh network includes an array of stationary sensing devices. Each of the devices is controlled by a microprocessor control unit and has a sensor capable of detecting a non-stationary object that enters a detection range of the sensor. A wireless communication component allows the sensing devices to wirelessly communicate with any other sensing devices or mobile phones within communication range. The devices include a power harvesting component that collects energy from the environment and a power capacitor that stores the collected energy. The devices automatically communicate data concerning any detected non-stationary objects to a central server.

### CROSS-REFERENCES TO RELATED APPLICATIONS

The present Utility patent application is based upon and claims priority from co-pending U.S. Provisional Patent Application No. 62/106,228 filed Jan. 22, 2015 entitled “Wireless Array”.

### STATEMENT REGARDING FEDERALLY SPONSORED RESEARCH OR DEVELOPMENT

Not Applicable.

### REFERENCE TO SEQUENCE LISTING OR COMPUTER PROGRAM LISTING APPENDIX

Not Applicable.

### BACKGROUND OF THE INVENTION

Often times it is desirable to have numerous sensing devices spread over a large area either gathering sensor information such as environmental conditions or the location of moving objects. As a result of the large number or location of the multiple sensing devices, it becomes impractical to run a wired power connection to each device. Therefore, many of these types of devices are battery powered. However, batteries fail over time and can leak corrosive substances which may damage the electronics of the device. In addition, the use of batteries leads to the need to repeatedly replace the batteries in the devices. In certain locations, this can be impractical or unsafe. Thus, there is a need for an improved long-term service free sensing device.

### BRIEF SUMMARY OF THE INVENTION

An embodiment of the present invention is directed toward an array or mesh network of devices. The array includes a plurality of stationary devices. Each of the stationary devices includes a microprocessor control unit and a sensor capable of detecting and tracking the location of a non-stationary object that enters a detection range of the sensor. A wireless communication component allows the stationary device to wirelessly transmit and receive digital data according to a standardized format. The communication component includes a broad field antenna and a directional antenna and the stationary device can automatically switch between using the broad field antenna and the directional antenna as needed. The wireless communication component is capable of wirelessly transmitting and receiving data from a portable electronic device having application software adapted to communicate with the stationary device. A power harvesting component collects power from an environment in which the stationary device is positioned and provides the power to the microprocessor control unit and the wireless communication component. A power capacitor provides energy storage for power harvested by the power harvesting component. An enclosure houses the microprocessor control unit, sensor, wireless communication component and power harvesting component. The plurality of stationary devices automatically communicate data concerning any detected non-stationary objects to at least one other of the stationary devices. Each device also transmits a unique identification number to any other stationary device within a transmission range of the stationary device that identifies the device. A central server receives the data produced by the plurality of stationary devices.

Another embodiment of the present invention is directed toward a network of devices. The network includes a plurality of sensing devices that include a microprocessor control unit and a wireless radio frequency communication component that allows the sensing device to wirelessly transmit and receive digital data according to a standardized format. The microprocessor control unit monitors an output of the wireless radio frequency communication component to detect movement within a detection range of the sensing device. A power harvesting component collects power from the environment in which the sensing device is positioned and provides the power to the microprocessor control unit and the wireless radio frequency communication component. An enclosure houses the microprocessor control unit, wireless radio frequency communication component and power harvesting component.

### BRIEF DESCRIPTION OF THE SEVERAL VIEWS OF THE DRAWINGS

FIG. 1 a block diagram of a sensing device constructed in accordance with an embodiment of the present invention; and

FIG. 2 is a block diagram of a wireless array of sensing devices connected to a central server in accordance with an embodiment of the present invention.

### DETAILED DESCRIPTION OF THE INVENTION

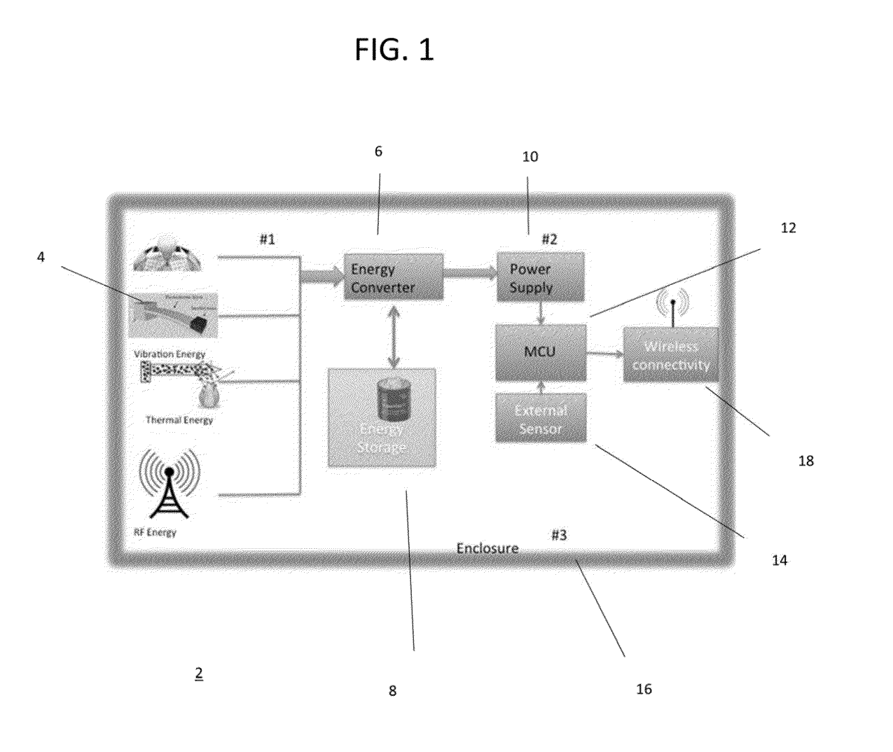

The present invention is directed toward a wireless array of sensing devices that is capable of collecting data in a target area and communicating that data wirelessly among the individual devices using a standardized transmission format. Referring now to FIG. 1, a block diagram of a sensing device constructed in accordance with an embodiment of the invention is shown. The stationary sensing device 2 is constructed with a power harvester 4 that harvests power from the device's local environment such that the device is self-powered. An energy converter 6 takes the power from the power harvester 4 and converts it into the proper voltage and current parameters for an energy storage device 8 and power supply 10. A microprocessor control unit 12 that controls the functions of the device 2 is powered by the power supply 10. The microprocessor control unit 12 preferably includes digital memory for any needed data storage.

The microprocessor control unit 12 receives input sensor data from a sensor 14. The sensor 14 may be mounted on the exterior or interior of the housing or enclosure 16 of the device 2 depending upon the type of sensor 14. The sensor 14 of the sensing device 2 is preferably capable of detecting the presence of non-stationary objects such as moving people. The sensor 14 may be a temperature, motion, or infrared type of sensor. However, different sensors 14 can be used in different applications.

The sensing device 2 wirelessly communicates directly with other stationary sensing devices and portable hand-held devices such as cellular telephones or purpose built devices through a low energy, radio frequency communication component 18 that includes a wireless transmitter and receiver that provide wireless connectivity to the device 2. The functioning of the communication component 18 is controlled by the microprocessor control unit 12.

The radio frequency communication component 18 of the sensing device 2 can be switched between a broad transmit and receive area operating mode or a more focused transmit and receive area operating mode depending on the application. For example, when configured in an array, the devices 2 would preferably use an antenna system in the radio frequency communication component 18 that has a broad transmission and reception field for communication between the devices 2 since this allows for the maximum spacing between individual devices in the array. Conversely, when trying to detect a mobile phone in a specified area, it might be desired to have the antenna only directed toward the particular specified area. In such a case, a longer range, more focused directional antenna network in the communication component 18 can be selected by placing the sensing device in a focused transmit and receive area operating mode. To change between broad-field and narrow-field operating modes, the device 2 selects between different antenna networks contained in the communication component 18. The antenna selection preferably happens automatically as a function of the device's 2 internal programming in the microprocessor control unit 12, although it can be dependent on an outside trigger or switch.

As discussed above, the stationary wireless sensing device 2 is preferably powered by a form of local energy scavenging or harvesting 4 such as solar energy, vibration energy, audio energy, thermal energy, wind, hydro, RF energy, etc. Utilizing energy scavenging eliminates the need for an auxiliary wired energy source or a short term replaceable consumable energy source such as a battery. This makes the installation of the devices easy while eliminating the need for maintenance related to the power source. The stationary device 2 preferably has a rechargeable reserve energy storage 8, such as a capacitor or rechargeable battery, in the event that the energy scavenging mechanism is unavailable for a period of time. The use of a power capacitor for energy storage 8 is preferred due to the low power requirements of the device 2 and the inexpensive and reliable nature of a power capacitor. The stationary devices 2 are capable of being programmed to be non-operational during specific times to conserve power or being placed in a stand-by low power mode.

In some applications, the sensor 14 of the device 2 may be implemented in the communication module 18. This is a result of the ability to use reflected wireless communication signals to determine the presence and movement of objects within the immediate area of a radio frequency wireless transmitter. When using the communication module 18 as the sensor 14, the antennas in the module 18 can be tuned and focused so that the detection area can be localized. Improvements in the use of radio frequency motion detection technology, the details of which are known but beyond the scope of the present application, have allowed the functionality of such a system to increase to the point that gesture recognition is readily available.

The communication component 18 in the device 2 preferably includes a radio frequency transmitter that preferably is low power, inexpensive and uses an open source data transmission scheme. Given the nature of low power, short range radio frequency transmission, an inexpensive low power radio frequency transmitter is well suited to functioning as sensor when mounted in the floor of an area to be monitored. A typical low power radio frequency transmitter has a detection range of about eight feet. Thus, the transmitter will detect a user and their mobile phone, which is generally held less than eight feet off the ground, when the user stands over the transmitter mounted in the floor. The communication component 18 functions as a sensor in such a location by detecting movement near transmitter.

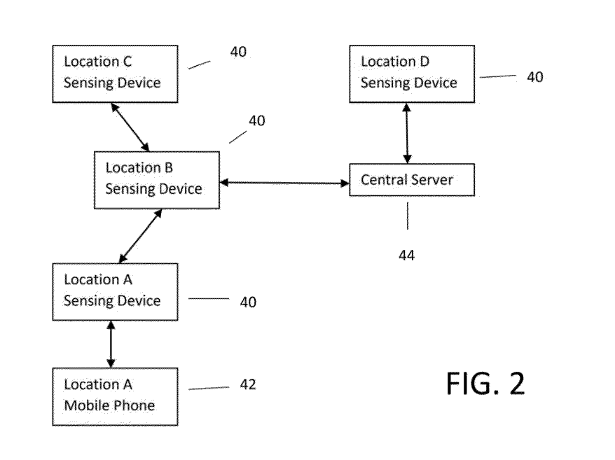

Referring now to FIG. 2, a block diagram of a wireless array of sensing devices managed by a central server in accordance with an embodiment of the present invention is shown. The stationary array of sensing devices 40 wirelessly communicate with each other as well as directly with any mobile devices 42 within the communication range of the array. The digital wireless communication preferably utilizes a standardized digital transmission format and is accomplished without the use of a wireless electronic bridge. This takes advantage of the existing short range radios found on many commercially available portable electronic devices. Using a standardized digital transmission format allows the data collected by the sensing devices 40 to be made directly available to other devices outside of the array and essentially worldwide. The placement and location of the individual sensing devices 40 in the array is determined by the particular application.

The array, or mesh network, of wireless sensing devices 40 is preferably capable of identifying and tracking the location of several non-stationary objects such as people or mobile phones moving in a large area covered by the array. In addition to collecting data from their sensors, the sensing devices 40 act as stationary communication beacons to other non-stationary 42 and stationary devices 40 such that data can be relayed between the stationary devices 40, non-stationary devices 42 and central server 44. For example, the sensing device 40 at location C can communicate data to, and receive data from, the central server 44 by using the sensing device 40 at location B to relay data. The routing and relaying of data is preferably automatically accomplished by the devices 40 determining the best path to each other and the server 44 based upon which other devices 40 are detectable by any given device.

The stationary sensing devices 40 have wireless receivers and transmitters that are capable of detecting, and communicating with, any non-stationary cellphones 42 or purpose built portable devices detected within the communication range of the device 40. The mobile devices 42 have application software, which can be uploaded from a device 40, which allows them to determine their location when communication is established between the mobile device 42 and the sensing device 40. This allows the mobile devices 42 to implement area specific functions based upon their programming and the detection of local sensing devices 40. A stationary device 40 and non-stationary device 42 have the ability to establish two-way communication when the non-stationary device moves within the communication range of the stationary device. The wireless communication between the mobile 42 and stationary devices 40 preferably uses an open standard data transmission scheme that allows for multiple platforms of non-stationary devices 42 to communicate with the stationary devices 40. When the stationary sensing device 40 is active, it preferably reports back to the central server 44 or another one of the devices 40 the location of any detected mobile devices 42 as well as any other relevant data.

When communication is established between a mobile phone 42 and the mesh array of devices 40, the mobile phone 42 becomes part of the mesh and can collect data from, or send data to, any device 40 in the mesh array. When the phone 42 enters the communication range of a stationary device 40, the phone 42 communicates with the device 40 getting sensor and real time location data, and the device 40 communicates any needed application data to the phone 42. Thus, in such an implementation, the device 40 acts as a beacon that activates application software in the mobile device 42 when detected. The detection of a particular stationary device 40 causes software in the mobile device 42 to perform a desired action associated with the device, such as playing a presentation related to a painting in a museum that a mobile phone user is currently viewing.

Each of the plurality of stationary sensing devices 40 transmits a unique identification number that allows other stationary 40 and mobile devices 42 and the central server 44 to uniquely identify and distinguish between the individual sensing devices 40. Non-stationary devices 42, such as a smartphone, have application software that records and timestamps the identification number of any sensing devices 40 detected as they are encountered. The non-stationary devices 40 can, either continuously or occasionally, connect to an external wireless network, such as Wi-Fi or cellular, to transmit any information recorded along with their identification number to the central server 44. If continually connected to the central server 44, any particular device's 40 or 42 location can be known in real time.

The stationary devices 40 can all be reprogrammed wirelessly starting with a single device in the array of devices, such as a stationary device 40, mobile device 42 or central server 44, and then that single device relays the new programming or data to the next stationary device 40 in the array. This device data reprogramming continues until all devices 40 in the network are reprogrammed. The stationary array of devices 40 can be programmed to act as one large collective group of units, or in subgroups, with no real limits to the grouping or arrangement of the sensing devices.

Although there have been described particular embodiments of the present invention of a new and useful Wireless Array, it is not intended that such references be construed as limitations upon the scope of this invention except as set forth in the following claims.

What is claimed is:

1. An array of devices, said array comprising:
a plurality of stationary devices, wherein each of said stationary devices comprises:
a microprocessor control unit;
a sensor capable of detecting a non-stationary object that enters a detection range of said sensor:
a wireless communication component that allows said stationary device to wirelessly transmit and receive digital data according to a standardized format;
a power harvesting component that collects power from an environment in which the stationary device is positioned and provides said power to said microprocessor control unit and said wireless communication component; and
an enclosure which houses said microprocessor control unit, sensor, wireless communication component and power harvesting component;
wherein each of said plurality of stationary devices automatically communicate data concerning any detected non-stationary objects to at least one other of said stationary devices.

2. The array of claim 1 wherein each one of said plurality of stationary devices transmits a unique identification number to any other stationary device within a transmission range of said stationary device.

3. The array of claim 1 wherein said communication component further comprises a broad field antenna and a directional antenna and said stationary device can automatically switch between using said broad field antenna and said directional antenna.

4. The array of claim 1 wherein said sensor is capable of tracking the location of a non-stationary object within a detection range of said sensor.

5. The array of claim 1 wherein each of said stationary devices further comprises a power capacitor that provides energy storage for power harvested by said power harvesting component.

6. The array of claim 1 further comprising a central server that receives data produced by said plurality of stationary devices.

7. The array of claim 1 wherein said communication component is capable of wirelessly transmitting and receiving data from a portable electronic device having application software adapted to communicate with said stationary device.

8. A mesh network, said mesh network comprising:
a plurality of stationary devices, wherein each of said stationary devices comprises:
a microprocessor control unit;
a sensor capable of detecting a non-stationary object that enters a detection range of said sensor:
a wireless communication component that allows said stationary device to wirelessly transmit and receive digital data according to a standardized format;
a power harvesting component that collects power from an environment in which the stationary device is positioned and provides said power to said microprocessor control unit and said wireless communication component; and
an enclosure which houses said microprocessor control unit, sensor, wireless communication component and power harvesting component;
wherein said wireless communication component further comprises a broad field antenna and a directional antenna and said stationary device can automatically switch between using said broad field antenna and said directional antenna.

9. The mesh network of claim 8 wherein each of said plurality of stationary devices automatically communicate data concerning any detected non-stationary objects to at least one other of said stationary devices.

10. The mesh network of claim 8 wherein said sensor is capable of tracking the location of a non-stationary object within a detection range of said sensor.

11. The mesh network of claim 8 wherein each of said stationary devices further comprises a power capacitor that provides energy storage for power harvested by said power harvesting component.

12. The mesh network of claim 8 further comprising a central server that receives any data produced by said plurality of stationary devices.

13. The mesh network of claim 8 wherein said wireless communication component is capable of wirelessly transmitting and receiving data from a portable electronic device having application software adapted to communicate with said stationary device.

14. A network of devices, said network comprising:
a plurality of sensing devices, wherein each of said sensing devices comprises:
a microprocessor control unit;
a wireless radio frequency communication component that allows said sensing device to wirelessly transmit and receive digital data according to a standardized format;
a power harvesting component that collects power from an environment in which the sensing device is positioned and provides said power to said microprocessor control unit and said wireless radio frequency communication component; and
an enclosure which houses said microprocessor control unit, wireless radio frequency communication component and power harvesting component;
wherein said microprocessor control unit monitors an output of said wireless radio frequency communication component to detect movement within a detection range of said sensing device.

15. The network of claim 14 wherein said wireless radio frequency communication component further comprises a broad field antenna and a directional antenna and said sensing device can automatically switch between using said broad field antenna and said directional antenna.

16. The network of claim 14 wherein each of said sensing devices further comprises a power capacitor that provides energy storage for power harvested by said power harvesting component.
